(19) United States
(12) Patent Application Publication
(10) Pub. No.: US 2014/0268377 A1
(43) Pub. Date: Sep. 18, 2014

(54) Ultrathin Coating for One Way Mirror Applications

(71) Applicant: Intermolecular, Inc., San Jose, CA (US)

(72) Inventors: Xuena Zhang, San Jose, CA (US); Dipankar Pramanik, Saratoga, CA (US)

(73) Assignee: Intermolecular, Inc., San Jose, CA (US)

(21) Appl. No.: 14/105,118

(22) Filed: Dec. 12, 2013

Related U.S. Application Data
(60) Provisional application No. 61/778,878, filed on Mar. 13, 2013.

(51) Int. Cl. G02B 5/08; G02B 1/10

(52) U.S. Cl. CPC G02B 5/08; G02B 1/105
USPC 359/839; 359/883; 204/192.27

(57) ABSTRACT

Systems and methods for improving the performance of one way mirror applications are disclosed. Methods consistent with the present disclosure include introducing a glass substrate into a processing chamber. The processing chamber comprises a sputter target assembly disposed over the substrate. Next, depositing metal silicide material within a plurality of site-isolated regions on the substrate to form a metal silicide coating within each region. Notably, each metal silicide coating has a thickness between 0.001 and 0.5 microns. Finally, evaluating results of the metal silicide coating formed within the plurality of site-isolated regions.

### CROSS-REFERENCE TO RELATED APPLICATIONS

This application claims priority to U.S. Provisional Application Ser. No. 61/778,878 filed on Mar. 13, 2013, which is herein incorporated by reference for all purposes.

### FIELD

The present disclosure relates to improving the performance of one way mirror applications.

### BACKGROUND

High tech glass products, such as one way mirrors, require a coating of highly reflective thin layer material. Typically, the glass substrate in these products are coated with, or encases, a thin and semi-transparent layer of metal (e.g., Al, Ag) resulting in a mirrored surface that reflects some light and transmits the rest. Persons on the brightly lit side of the one way mirror see their own reflection—it appears as a normal mirror. However, persons on the dark side of the one way mirror can see through it—appearing as a transparent window.

Noticeably, the light from the bright side reflected from the one way mirror back into the bright side is much greater than the light transmitted from the dark side which overwhelms the small amount of light transmitted from the dark side through the one way mirror to the bright side. Conversely, the light reflected back into the dark side is overwhelmed by the light transmitted from the bright side which allows an observer in the dark side to observe the bright room covertly.

For some one way mirror applications, the reflectance (R) of the glass composite (glass substrate and coating), particularly the metal coating, should be close to 50%. Although using metal coating(s) for one way mirror applications is known, many highly refractive index materials which have a R˜50% have not yet been explored. Accordingly, a need exists to identify materials with suitable reflectance for one way mirror applications. The present disclosure addresses this need.

### SUMMARY OF THE DISCLOSURE

The following summary is included in order to provide a basic understanding of some aspects and features of the present disclosure. This summary is not an extensive overview of the disclosure and it is not intended to particularly identify key or critical elements of the disclosure or to delineate the scope of the disclosure. Its sole purpose is to present some concepts of the disclosure in a simplified form as a prelude to the more detailed description that is presented below.

Systems and methods for improving the performance of one way mirror applications are disclosed. Methods consistent with the present disclosure include introducing a glass substrate into a processing chamber. The processing chamber comprises a sputter target assembly disposed over the substrate. Next, depositing metal silicide material within a plurality of site-isolated regions on the substrate to form a metal silicide coating within each region. Notably, each metal silicide coating has a thickness between 0.001 and 0.5 microns. Finally, the method includes evaluating results of the metal silicide coating formed within the plurality of site-isolated regions.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale. The techniques of the present disclosure may readily be understood by considering the following detailed description in conjunction with the accompanying drawings, in which:

FIG. 1 is a schematic diagram for implementing combinatorial processing.

FIG. 2 is a schematic diagram for illustrating various process sequences using combinatorial processing and evaluation.

FIG. 3 is a simplified schematic diagram illustrating an integrated high productivity combinatorial (HPC) system.

FIG. 4 is a simplified schematic diagram illustrating a processing chamber configured to perform combinatorial processing and full substrate processing.

FIG. 5 is a graph illustrating reflectance values as a function of refractive index for non-absorbing films.

FIG. 6 is a graph illustrating transmission values as a function of wavelength of light for a conventional glass material.

FIG. 7 is a graph illustrating reflectance values as a function of wavelength of light for non-absorbing films.

FIG. 8 is a graph illustrating reflectance values as a function of wavelength of light for Al and MoSi₂ films on a glass substrate.

FIG. 9 is a simplified schematic diagram illustrating a cross-section of a device consistent with the present disclosure.

FIG. 10 is a flowchart of a method for forming a device consistent with the present disclosure.

FIG. 11A-11B is a simplified schematic diagram illustrating an exemplary deposition sequence for forming a composite glass material having a metal silicide film thereon.

FIG. 12A-12C is a simplified schematic diagram illustrating another exemplary deposition sequence for forming a composite glass material having a metal silicide film and a protective layer formed thereon.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to some embodiments have not been described in detail to avoid unnecessarily obscuring the description.

Systems and methods for improving the performance of one way mirror applications are disclosed. Methods consistent with the present disclosure include introducing a glass substrate into a processing chamber. The processing chamber comprises a sputter target assembly disposed over the substrate. Next, depositing metal silicide material within a plurality of site-isolated regions on the substrate to form a metal silicide coating within each region. Notably, each metal silicide coating has a thickness between 0.001 and 0.5 microns. Finally, evaluating results of the metal silicide coating formed within the plurality of site-isolated regions.

It is to be understood that unless otherwise indicated this disclosure is not limited to specific layer compositions or surface treatments. It is also to be understood that the terminology used herein is for the purpose of describing particular embodiments only and is not intended to limit the scope of the present disclosure.

It must be noted that as used herein and in the claims, the singular forms “a,” and “the” include plural referents unless the context clearly dictates otherwise. Thus, for example, reference to “a layer” also includes two or more layers, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure. The term “about” or “approximately” generally refers to ±10% of a stated value.

The term “site-isolated processing” as used herein refers to providing distinct processing conditions, such as controlled temperature, flow rates, chamber pressure, processing time, plasma composition, and plasma energies. Site isolation may provide complete isolation between regions or relative isolation between regions. Preferably, the relative isolation is sufficient to provide a control over processing conditions within ±10%, within ±5%, within ±2%, within ±1%, or within ±0.1% of the target conditions. Where one region is processed at a time, adjacent regions are generally protected from any exposure that would alter the substrate surface in a measurable way.

The term “site-isolated region” as used herein refers to a localized area on a substrate which is, was, or is intended to be used for processing or formation of a selected material. The region may include one region and/or a series of regular or periodic regions predefined on the substrate. The region may have any convenient shape, e.g., circular, rectangular, elliptical, wedge-shaped, etc. In the semiconductor field, a region may be, for example, a test structure, single die, multiple dies, portion of a die, other defined portion of substrate, or an undefined area of a substrate, e.g., blanket substrate which is defined through the processing.

The term “substrate” as used herein may refer to any workpiece on which formation or treatment of material layers is desired. Substrates may include, without limitation, silicon, coated silicon, other semiconductor materials, glass, polymers, metal foils, sapphire, aluminum oxide, etc. The term “substrate” or “wafer” may be used interchangeably herein. Semiconductor wafer shapes and sizes may vary and include commonly used round wafers of 2″, 4″, 200 mm, or 300 mm in diameter.

It is desirable to be able to: i) test different materials, ii) test different processing conditions within each unit process module, iii) test different sequencing and integration of processing modules within an integrated processing tool, iv) test different sequencing of processing tools in executing different process sequence integration flows, and combinations thereof in the manufacture of devices. In particular, there is a need to be able to test i) more than one material, ii) more than one processing condition, iii) more than one sequence of processing conditions, iv) more than one process sequence integration flow, and combinations thereof, collectively known as “combinatorial process sequence integration,” on a single substrate without the need of consuming the equivalent number of monolithic substrates per material(s), processing condition(s), sequence(s) of processing conditions, sequence(s) of processes, and combinations thereof. This may greatly improve both the speed and reduce the costs associated with the discovery, implementation, optimization, and qualification of material(s), process(es), and process integration sequence(s) required for manufacturing.

Systems and methods for HPC™ processing are described in U.S. Pat. No. 7,544,574 filed on Feb. 10, 2006; U.S. Pat. No. 7,824,935 filed on Jul. 2, 2008; U.S. Pat. No. 7,871,928 filed on May 4, 2009; U.S. Pat. No. 7,902,063 filed on Feb. 10, 2006; and U.S. Pat. No. 7,947,531 filed on Aug. 28, 2009 which are all herein incorporated by reference for all purposes.

Systems and methods for HPC™ processing are further described in U.S. Pat. No. 8,084,400 filed on Feb. 10, 2006, claiming priority from Oct. 15, 2005; U.S. Patent Application No. 2007/0267631 filed on May 18, 2006, claiming priority from Oct. 15, 2005; U.S. Patent Application No. 2007/0202614 filed on Feb. 12, 2007, claiming priority from Oct. 15, 2005; U.S. Patent Application No. 2013/0065355 filed on Sep. 12, 2011, and U.S. Patent Application No. 2007/0202610 filed on Feb. 12, 2007, claiming priority from Oct. 15, 2005 which are all herein incorporated by reference for all purposes.

HPC™ processing techniques have been successfully adapted to wet chemical processing such as etching, texturing, polishing, cleaning, etc. HPC™ processing techniques have also been successfully adapted to deposition processes such as physical vapor deposition (PVD) (i.e. sputtering), atomic layer deposition (ALD), and chemical vapor deposition (CVD).

In addition, systems and methods for combinatorial processing are further described in U.S. Patent Application No. 2013/0168231 filed on Dec. 31, 2011 and U.S. Patent Application No. 2013/0130490 filed on Nov. 22, 2011 which are all herein incorporated by reference for all purposes.

FIG. 1 illustrates a schematic diagram 100 for implementing combinatorial processing and evaluation using primary, secondary, and tertiary screening. The schematic diagram 100 illustrates that the relative number of combinatorial processes run with a group of substrates decreases as certain materials and/or processes are selected. Generally, combinatorial processing includes performing a large number of processes during a primary screen, selecting promising candidates from those processes, performing the selected processing during a secondary screen, selecting promising candidates from the secondary screen for a tertiary screen, and so on. In addition, feedback from later stages to earlier stages may be used to refine the success criteria and provide better screening results.

For example, thousands of materials are evaluated during a materials discovery stage 102. Materials discovery stage 102 is also known as a primary screening stage performed using primary screening techniques. Primary screening techniques may include dividing substrates into coupons and depositing materials using varied processes. The materials are then evaluated, and promising candidates are advanced to the secondary screen, or materials and process development stage 104. Evaluation of the materials is performed using metrology tools such as electronic testers and imaging tools (i.e., microscopes).

The materials and process development stage 104 may evaluate hundreds of materials (i.e., a magnitude smaller than the primary stage) and may focus on the processes used to deposit or develop those materials. Promising materials and processes are again selected, and advanced to the tertiary screen or process integration stage 106 where scores of materials and/or processes and combinations are evaluated. The tertiary screen or process integration stage 106 may focus on integrating the selected processes and materials with other processes and materials.

The most promising materials and processes from the tertiary screen are advanced to device qualification 108. In device qualification, the materials and processes selected are evaluated for high volume manufacturing, which normally is conducted on full substrates within production tools, but need not be conducted in such a manner. The results are evaluated to determine the efficacy of the selected materials and processes. If successful, the use of the screened materials and processes may proceed to pilot manufacturing 110.

The schematic diagram 100 is an example of various techniques that may be used to evaluate and select materials and processes for the development of new materials and processes. The descriptions of primary, secondary, etc. screening and the various stages 102-110 are arbitrary and the stages may overlap, occur out of sequence, be described and be performed in many other ways.

This application benefits from HPC™ techniques described in U.S. Patent Application No. 2007/0202610 filed on Feb. 12, 2007 which is hereby incorporated for reference for all purposes. Portions of the '137 application have been reproduced below to enhance the understanding of the present disclosure.

While the combinatorial processing varies certain materials, unit processes, hardware details, or process sequences, the composition or thickness of the layers or structures or the action of the unit process, such as cleaning, surface preparation, deposition, surface treatment, etc. is substantially uniform through each discrete site-isolated region. Furthermore, while different materials or unit processes may be used for corresponding layers or steps in the formation of a structure in different site-isolated regions of the substrate during the combinatorial processing, the application of each layer or use of a given unit process is substantially consistent or uniform throughout the different site-isolated regions in which it is intentionally applied. Thus, the processing is uniform within a site-isolated region (inter-region uniformity) and between site-isolated regions (intra-region uniformity), as desired. It should be noted that the process may be varied between site-isolated regions, for example, where a thickness of a layer is varied or a material may be varied between the site-isolated regions, etc., as desired by the design of the experiment.

The result is a series of site-isolated regions on the substrate that contain structures or unit process sequences that have been uniformly applied within that site-isolated region and, as applicable, across different site-isolated regions. This process uniformity allows comparison of the properties within and across the different site-isolated regions such that the variations in test results are due to the varied parameter (e.g., materials, unit processes, unit process parameters, hardware details, or process sequences) and not the lack of process uniformity. In the embodiments described herein, the positions of the discrete site-isolated regions on the substrate may be defined as needed, but are preferably systematized for ease of tooling and design of experimentation. In addition, the number, variants and location of structures within each site-isolated region are designed to enable valid statistical analysis of the test results within each site-isolated region and across site-isolated regions to be performed.

FIG. 2 is a simplified schematic diagram illustrating a general methodology for combinatorial process sequence integration that includes site-isolated processing and/or conventional processing. In some embodiments, the substrate is initially processed using conventional process N. In some exemplary embodiments, the substrate is then processed using site-isolated process N−1. During site-isolated processing, an HPC™ module may be used, such as the HPC module described in U.S. Pat. No. 8,084,400 filed on Feb. 10, 2006, which is incorporated herein by reference for all purposes. The substrate may then be processed using site-isolated process N+2, and thereafter processed using conventional process N+3. Testing is performed and the results are evaluated. The testing may include physical, chemical, acoustic, magnetic, electrical, optical, etc. tests. From this evaluation, a particular process from the various site-isolated processes (e.g. from steps N+1 and N+2) may be selected and fixed so that additional combinatorial process sequence integration may be performed using site-isolated processing for either process N or N+3. For example, a next process sequence may include processing the substrate using site isolated process N, conventional processing for processes N−1, N+2, and N+3, with testing performed thereafter.

It should be appreciated that various other combinations of conventional and combinatorial processes may be included in the processing sequence with regard to FIG. 2. That is, the combinatorial process sequence integration may be applied to any desired segments and/or portions of an overall process flow. Characterization, including physical, chemical, acoustic, magnetic, electrical, optical, etc. testing, may be performed after each process operation, and/or series of process operations within the process flow as desired. The feedback provided by the testing is used to select certain materials, processes, process conditions, and process sequences and eliminate others. Furthermore, the above flows may be applied to entire monolithic substrates, or portions of monolithic substrates such as coupons.

Under combinatorial processing operations the processing conditions at different site-isolated regions may be controlled independently. Consequently, process material amounts, reactant species, processing temperatures, processing times, processing pressures, processing flow rates, processing powers, processing reactant compositions, the rates at which the reactions are quenched, deposition order of process materials, process sequence steps, hardware details, etc., may be varied from site-isolated region to site-isolated region on the substrate. Thus, for example, when exploring materials, a processing material delivered to a first and second site-isolated region may be the same or different. If the processing material delivered to the first site-isolated region is the same as the processing material delivered to the second isolated-region, this processing material may be offered to the first and second site-isolated regions on the substrate at different concentrations. In addition, the material may be deposited under different processing parameters. Parameters which may be varied include, but are not limited to, process material amounts, reactant species, processing temperatures, processing times, processing pressures, processing flow rates, processing powers, processing reactant compositions, the rates at which the reactions are quenched, atmospheres in which the processes are conducted, an order in which materials are deposited, hardware details of the gas distribution assembly, etc. It should be appreciated that these process parameters are exemplary and not meant to be an exhaustive list as other process parameters commonly used may be varied.

As mentioned above, within a site-isolated region, the process conditions are substantially uniform. That is, the embodiments, described herein locally perform the processing in a conventional manner, e.g., substantially consistent and substantially uniform, while globally over the substrate, the materials, processes, and process sequences may vary. Thus, the testing will find optimums without interference from process variation differences between processes that are meant to be the same. However, in some embodiments, the processing may result in a gradient within the site-isolated regions. It should be appreciated that a site-isolated region may be formed on another site-isolated region in some embodiments or the site-isolated regions may be isolated and, therefore, non-overlapping. When the site-isolated regions are adjacent, there may be a slight overlap wherein the materials or precise process interactions are not known, however, a portion of the site-isolated regions, normally at least 50% or more of the area, is uniform and all testing occurs within that site-isolated region. Further, the potential overlap is only allowed with material of processes that will not adversely affect the result of the tests. Both types of site-isolated regions are referred to herein as site-isolated regions or discrete site-isolated regions.

Substrates may be a conventional round 200 mm, 300 mm, or any other larger or smaller substrate/wafer size. In some embodiments, substrates may be square, rectangular, or any other shape. One skilled in the art may appreciate that the substrate may be a blanket substrate, a coupon (e.g., partial wafer), or even a patterned substrate having predefined site-isolated regions. In some other embodiments, a substrate may have site-isolated regions defined through the processing described herein.

FIG. 3 is a simplified schematic diagram illustrating a HPC system. The HPC system includes a frame 300 supporting a plurality of processing modules. It will be appreciated that frame 300 may be a unitary frame in accordance with some embodiments. In some embodiments, the environment within frame 300 is controlled. A load lock 302 provides access into the plurality of modules of the HPC system. A robot 314 provides for the movement of substrates (and masks) between the modules and for the movement into and out of the load lock 302. Modules 304-312 may be any set of modules and preferably include one or more combinatorial modules. For example, module 304 may be an orientation/degassing module, module 306 may be a clean module, either plasma or non-plasma based, modules 308 and/or 310 may be combinatorial/conventional dual purpose modules. Module 312 may provide conventional clean or degas as necessary for the experiment design.

FIG. 4 is a simplified schematic diagram illustrating a processing chamber 400 configured to perform combinatorial processing and full substrate processing. Processing chamber 400 includes a bottom chamber portion 402 disposed under top chamber portion 418. Within bottom portion 402, substrate support 404 is configured to hold a substrate 406 disposed thereon and can be any known substrate support, including but not limited to a vacuum chuck, electrostatic chuck or other known mechanisms. Substrate support 404 is capable of both rotating around its own central axis 408 (referred to as “rotation” axis), and rotating around an exterior axis 410 (referred to as “revolution” axis). Such dual rotary substrate support is central to combinatorial processing using site-isolated mechanisms. Other substrate supports, such as an XY table, can also be used for site-isolated deposition. In addition, substrate support 404 may move in a vertical direction. It should be appreciated that the rotation and movement in the vertical direction may be achieved through known drive mechanisms which include magnetic drives, linear drives, worm screws, lead screws, a differentially pumped rotary feed through drive, etc. In some embodiments, substrate support 404 is stationary and the central axis of the substrate support is aligned with masks utilized for processing a substrate as described below.

Power source 426 provides a bias power to substrate support 404 and substrate 406, and produces a negative bias voltage on substrate 406. In some embodiments power source 426 provides a radio frequency (RF) power sufficient to take advantage of the high metal ionization to improve step coverage of vias and trenches of patterned wafers. In some embodiments, the RF power supplied by power source 426 is pulsed and synchronized with the pulsed power from power source 424. Further details of the power sources and their operation may be found in U.S. patent application Ser. No. 13/281,316 entitled “High Metal Ionization Sputter Gun” filed on Oct. 25, 2011 with internal docket number (IMO281) and is herein incorporated by reference.

Substrate 406 may be a conventional round 200 mm, 300 mm, or any other larger or smaller substrate/wafer size. In some embodiments, substrate 406 may be a square, rectangular, or other shaped substrate. One skilled in the art will appreciate that substrate 406 may be a blanket substrate, a coupon (e.g., partial wafer), or even a patterned substrate having predefined site-isolated regions. In some embodiments, substrate 406 may have site-isolated regions defined through the processing described herein. The term site-isolated region is used herein to refer to a localized area on a substrate which is, was, or is intended to be used for processing or formation of a selected material. The site-isolated region can include one site-isolated region and/or a series of regular or periodic site-isolated regions predefined on the substrate. The site-isolated region may have any convenient shape, e.g., circular, rectangular, elliptical, wedge-shaped, etc. In the semiconductor field a site-isolated region may be, for example, a test structure, single die, multiple dies, portion of a die, other defined portion of substrate, or an undefined area of a substrate, e.g., blanket substrate which is defined through the processing.

Top chamber portion 418 of chamber 400 in FIG. 4 includes process kit shield 412, which defines a confinement site-isolated region over a radial portion of substrate 406. In some embodiments, process kit shield 412 is a sleeve having a base (optionally integrated with the shield) and an optional top within chamber 400 that may be used to confine a plasma generated therein. The generated plasma will dislodge atoms from a target and the sputtered atoms will deposit on an exposed surface of substrate 406 to combinatorial process site-isolated regions of the substrate in some embodiments. In some embodiments, full wafer processing can be achieved by optimizing gun tilt angle and target-to-substrate spacing, and by using multiple process guns 416. Process kit shield 412 is capable of being moved in and out of chamber 400, i.e., the process kit shield is a replaceable insert. In some embodiments, process kit shield 412 remains in the chamber for both the full substrate and combinatorial processing. Process kit shield 412 includes an optional top portion, sidewalls and a base. In some embodiments, process kit shield 412 is configured in a cylindrical shape, however, the process kit shield may be any suitable shape and is not limited to a cylindrical shape.

The base of process kit shield 412 includes an aperture 414 through which a surface of substrate 406 is exposed for deposition or some other suitable semiconductor processing operations. Aperture shutter 420 which is moveably disposed over the base of process kit shield 412. Aperture shutter 420 may slide across a bottom surface of the base of process kit shield 412 in order to cover or expose aperture 414 in some embodiments. In some embodiments, aperture shutter 420 is controlled through an arm extension which moves the aperture shutter to expose or cover aperture 414. It should be noted that although a single aperture is illustrated, multiple apertures may be included. Each aperture may be associated with a dedicated aperture shutter or an aperture shutter can be configured to cover more than one aperture simultaneously or separately. Alternatively, aperture 414 may be a larger opening and plate 420 may extend with that opening to either completely cover the aperture or place one or more fixed apertures within that opening for processing the defined site-isolated regions. In some embodiments, the base of process kit shield is replaced by independently rotatable masks configured to access and expose a desired site-isolated region of substrate 406 as described below.

A gun shutter, 422 may be included. Gun shutter 422 functions to seal off a deposition gun when the deposition gun may not be used for the processing in some embodiments. For example, two process guns 416 are illustrated in FIG. 4. Process guns 416 are moveable in a vertical direction so that one or both of the guns may be lifted from the slots of the shield. While two process guns are illustrated, any number of process guns may be included, e.g., one, three, four or more process guns may be included. Where more than one process gun is included, the plurality of process guns may be referred to as a cluster of process guns. Gun shutter 422 can be transitioned to isolate the lifted process guns from the processing area defined within process kit shield 412. In this manner, the process guns are isolated from certain processes when desired.

It should be appreciated that slide cover plate 422 may be integrated with the top of the process kit shield 412 to cover the opening as the process gun is lifted or individual cover plate 422 can be used for each target. In some embodiments, process guns 416 are oriented or angled so that a normal reference line extending from a planar surface of the target of the process gun is directed toward an outer periphery of the substrate in order to achieve good uniformity for full substrate deposition film. The target/gun tilt angle depends on the target size, target-to-substrate spacing, target material, process power/pressure, etc.

Top chamber portion 418 of chamber 400 of FIG. 4 includes sidewalls and a top plate which house process kit shield 412. Arm extensions 416a, which are fixed to process guns 416 may be attached to a suitable drive, e.g., lead screw, worm gear, etc., configured to vertically move process guns 416 toward or away from a top plate of top chamber portion 418. Arm extensions 416a may be pivotally affixed to process guns 416 to enable the process guns to tilt relative to a vertical axis. In some embodiments, process guns 416 tilt toward aperture 414 when performing combinatorial processing and tilt toward a periphery of the substrate being processed when performing full substrate processing. It should be appreciated that process guns 416 may tilt away from aperture 414 when performing combinatorial processing in some embodiments. In addition, arm extensions 416a may be attached to a bellows that allows for the vertical movement and tilting of process guns 416. Arm extensions 416a enable movement with four degrees of freedom in some embodiments. Where process kit shield 412 is utilized, the aperture openings are configured to accommodate the tilting of the process guns. The amount of tilting of the process guns may be dependent on the process being performed in some embodiments.

Power source 424 provides power for sputter guns 416 whereas power source 426 provides RF bias power to an electrostatic chuck to bias the substrate when necessary. It should be appreciated that power source 424 may output a direct current (DC) power supply or a radio frequency (RF) power supply.

Chamber 400 includes auxiliary magnet 428 disposed around an external periphery of the chamber. The auxiliary magnet 428 is located in a site-isolated region defined between the bottom surface of sputter guns 416 and a top surface of substrate 406. Magnet 428 may be either a permanent magnet or an electromagnet. It should be appreciated that magnet 428 is utilized to provide more uniform bombardment of argon ions and electrons to the substrate in some embodiments. In addition, auxiliary magnet may be disposed proximate to substrate support 404. Alternatively, auxiliary magnet may be integrated within substrate support 404.

Generally, a gas source supplies a sputtering working gas (or gases), such as argon, to a chamber through a mass flow controller. The gases may be admitted through the top of the chamber, as illustrated, or at its bottom, either with one or more inlet pipes penetrating the bottom of the shield or through the gap between the shield and the pedestal. A vacuum system maintains the chamber at a low pressure. Although the base pressure can be held to about 10⁻⁷ Torr or even lower, the pressure of the working gas is typically maintained at between about 1 and 1000 mTorr. A computer-based controller controls the reactor including the DC power supply and the mass flow controllers.

When the argon is admitted into the chamber, the DC voltage between the target and the shield ignites the argon into a plasma, and the positively charged argon ions are attracted to the negatively charged target. The ions strike the target at a substantial energy and cause target atoms or atomic clusters to be sputtered from the target. Some of the target particles strike the wafer and are thereby deposited on it, thereby forming a film of the target material. In reactive sputtering of a metallic nitride, nitrogen is additionally admitted into the chamber, and it reacts with the sputtered metallic atoms to form a metallic nitride on the wafer.

To provide efficient sputtering, a magnetron is positioned in back of the target. Conventional magnetrons include magnets which create a magnetic field within the sputter chamber 400 in the neighborhood of the magnets. The magnetic field traps electrons and, for charge neutrality, the ion density also increases to form a high-density plasma site-isolated region within the sputter chamber 400 adjacent to the magnetron. The magnetron is usually rotated about the center of the target to achieve full coverage in sputtering of the target.

FIG. 5 is a graph 500 illustrating reflectance values (y-axis) as a function of refractive index (n) (x-axis) for non-absorbing films. As shown, a reflectance curve 501 indicates that the reflectance values decreases from 0 to 1 but increases from 1 and beyond (e.g., to 12). Notably, the reflectance values are the lowest near a refractive index of 1 and are the highest for a refractive index much less (e.g., >0.15) than 1 and greater than 4.

For some applications, such as one way mirrors (or half-silvered mirrors), a reflectance value of approximately 50% may be particularly useful. It should be understood by one having ordinary skill in the art that a material with reflectance value of approximately 50% has a refractive index of approximately 5.0 (e.g., n˜4.8 regime). It should be appreciated by those have ordinary skill in the art that materials with a reflectance of 50% may be able to transmit approximately 50% of light incident on the materials while also reflecting approximately 50% of incident light in the visible wavelength spectrum.

One way mirrors may be formed provided from materials having a reflectance close to 50% (e.g., 45%-55%). Accordingly, various materials which have a refractive index which is near 0.15 or 5.0 may be possible candidates as coatings disposed upon a glass substrate for commercial applications consistent with the present disclosure.

Several metal silicide materials have a refractive index of approximately 5.0 which yield a reflectance of approximately 50%. For example, molybdenum silicide (MoSiₓ), vanadium silicide (VSiₓ), tungsten silicide (WSiₓ), titanium silicide (TiSiₓ), tantalum silicide (TaSiₓ), niobium silicide (NbSiₓ), hafnium silicide (HfSiₓ), and zirconium silicide (ZrSiₓ) are examples of such.

In some embodiments, a film comprising molybdenum disilicide (MoSi₂) is formed upon a glass substrate for use as a one way mirror device for various commercial applications.

Molybdenum disilicide films have a refractive index of approximately 4.8 which yields a reflectance of near 50% and are characteristically semi-transparent. Also, other molybdenum silicide films (MoSiₓ) (1.5≦X≦2.5) may yield a reflectance near 50% which may be useful for applications consistent with the present disclosure.

Advantageously, molybdenum silicide films have a Vickers hardness between 15-22 GPa. The relatively high hardness value of molybdenum silicide films may provide extra benefits for a MoSiₓ film formed on a substrate (e.g., glass substrate). For example, the hardness of molybdenum silicide films may provide an anti-scratch coating for a glass based product in high tech applications.

FIG. 6 is a graph 600 illustrating transmission values (y-axis) as a function of wavelength of light within the visible spectrum (x-axis) for a conventional glass material. In particular, the transmission values indicated by transmission curve 601 are properties of a borosilicate glass material. Borosilicate glass materials are known to have a refractive index of approximately 1.4-1.5 which is consistent with the reflectance values illustrated on the graph 600.

Aluminum is often used as a coating film on glass materials to reduce the transmittance (and therefore enhance the reflectance) of composite glass materials. However, attempts to optimize aluminum and other similar metallic material films for higher reflectance often fall short of achieving the 50% reflectance mark for one way mirror applications.

As shown by transmission curve 601, most of the light in the visible spectrum incident upon the borosilicate glass material is transmitted therethrough. Most notably, greater than 95% of incident light is transmitted through the borosilicate glass material. FIG. 7 is a graph 700 illustrating reflectance values as a function of wavelength of light for non-absorbing films. Reflectance curve 701 is consistent with the transmission curve 601 from FIG. 6. As shown, less than 5% of incident light is reflected from the borosilicate glass material.

For commercial applications which use one way mirror devices, a coating may be applied to conventional glass material (e.g., borosilicate glass) to modify the transmittance (and therefore reflectance) of composite glass materials. The metal silicide materials previously described may be used as coatings upon a glass substrate to provide the desired reflectance for composite glass materials. For instance, molybdenum silicide materials may be particularly useful to reduce the overall reflectance of glass composite materials and provide an anti-scratch coating on the glass substrate.

FIG. 8 is a graph 800 illustrating reflectance values (y-axis) as a function of wavelength of visible light (x-axis) for Al and MoSi₂ coatings formed on a glass substrate. As shown, reflectance curves 801, 802 indicate the difference in reflectance values for a molybdenum disilicide coating and an aluminum coating formed on a glass substrate.

Most notably, reflectance curve 802 illustrates that for the wavelengths of light represented, the reflectance values hover around 50%. Accordingly, molybdenum dislicide provides a suitable material for a coating on a composite glass material to reduce the reflectance for use as a one way mirror device for commercial applications.

FIG. 9 is a simplified schematic diagram illustrating a cross-section of a device 900 consistent with the present disclosure. In some embodiments, device 900 is used as a one way mirror. As shown, device 900 includes a glass substrate 901 having a metal silicide coating 902 formed thereon. Glass substrate 901 may comprise a conventional glass material such as borosilicate glass. In addition, metal silicide coating 902 may be any of molybdenum silicide (MoSiₓ), vanadium silicide (VSiₓ), tungsten silicide (WSiₓ), titanium silicide (TiSiₓ), tantalum silicide (TaSiₓ), niobium silicide (NbSiₓ), hafnium silicide (HfSiₓ), and zirconium silicide (ZrSiₓ).

In some embodiments, device 900 may comprise a protective layer (see FIGS. 11-12) formed upon the metal silicide coating 902 to provide additional protection for thin coatings 902 (e.g., less than 1 micron).

Due to the material advantages metal silcide coating 902 provides for device 900, device 900 may be incorporated into various commercial applications. For instance, device 900 may be incorporated into a window of an automobile. In this application, device 900 may provide a motorist the ability to view persons and objects external to the motorist's vehicle without persons external to the vehicle having the capability to easily view the inside of the vehicle through the window comprising the device 900.

In addition, device 900 may be incorporated within a glass window of an interrogation room. One having ordinary skill in the art may appreciate that a glass window of an interrogation room may be designed such that law enforcement or other observers can view from a dark room the interrogation, interview, deposition, etc. of a suspect or other person in a bright room adjacent to the interrogation glass window.

It should be further understood by one having ordinary skill in the art that the bright room in which the interrogation, etc. takes place has significantly more light than the dark room in which the observers are located. An interrogation glass window consistent with the present disclosure may have a coating comprising a metal silicide material such as molybdenum silicide formed to achieve a reflectance of approximately 50%.

Accordingly, the observers may view the interrogation without the suspect having the ability to identify the observers. Device 902 may also be incorporated in and used for other commercial applications such, as but not limited to, experimental research applications, security cameras, teleprompters, stage effects, and low-emissivity windows in homes and automobiles.

One having ordinary skill in the art may appreciate that forming one or more of the aforementioned commercial devices may include using a linear coater to deposit a metal silicide coating consistent with the present disclosure upon a glass substrate. For instance, a linear coater may be used to deposit a molybdenum disilicide coating upon a prefabricated window for an automobile.

FIG. 10 is a simplified schematic diagram illustrating a method 1000 for forming a device consistent with the present disclosure. As shown, method 1000 begins with block 1001—introducing a glass substrate into a process chamber wherein the process chamber comprises a sputter target assembly disposed over the substrate. In particular, the processing chamber 400 illustrated in FIG. 4 is suitable to form a device having a metal silicide coating consistent with the present disclosure formed thereon.

Next, forming a metal silicide film within a plurality of site-isolated regions on the glass substrate (block 1002). In some embodiments, the metal silicide films are deposited on the site-isolated regions by a PVD process technique. Referring back to FIG. 4, in some embodiments one of the sputter guns 416 includes a molybdenum (Mo) target therein and emits molybdenum atoms upon a glass substrate 406 when in process. In addition, another sputter gun 416 may include a MoSiₓ target therein to emit MoSiₓ atoms upon glass substrate 406 when in process. In some embodiments, the other sputter gun 416 comprises a MoSi_{2.5} target. Accordingly, the processing chamber 400 may be used to deposit a MoSiₓ film upon a glass substrate 406 as will be described in more detail below.

The deposited metal silicide films may have a thickness between 0.001 and 0.5 microns. In some embodiments, at least one of the deposited metal silicide films has a thickness of approximately 0.1 micron.

Lastly, block 1003 provides evaluating results of the metal silicide films within the plurality of site-isolated regions. In some embodiments, evaluating results comprises comparing an optical, physical, or electrical characteristic of the metal silicide films within the plurality of site-isolated regions.

FIGS. 11A-11B is a simplified schematic diagram illustrating an exemplary deposition sequence for forming a composite glass material having a metal silicide film formed thereon. A sequence for forming a composite glass material having a metal silicide coating formed on a glass substrate will be used as an example. Those skilled in the art will understand that the glass substrate may already have several layers formed thereon. FIG. 11A begins with the glass substrate 1100, wherein the glass substrate (or a previous material deposited thereon) is operable as a base upon which a metal silicide coating is formed thereon.

In FIG. 11B, four alternatives of a first material are formed above the glass substrate 1100 wherein the first material is operable as a metal silcide coating. As illustrated in FIG. 11B, the four alternatives are formed in each of four site-isolated regions 1101a-1101d across the glass substrate 1100 which may be accomplished using a combinatorial deposition processing chamber (see FIG. 4).

In the processing chamber, a substrate support, aperture shutter, or other component(s) may be used to deposit the first material in each site-isolated region of the glass substrate 1100.

In some embodiments, the first material is formed upon the glass substrate 1100 by a PVD process. In addition, the first material may be formed by varying process conditions (e.g., process time, temperature, etc.) for each site-isolated region. Moreover, the first material formed in each site-isolated region may have different concentrations of silicide. For instance, in site-isolated region 1101a, a MoSi_{1.5} film may be formed therein and in site-isolated region 1101b, a MoSi₂ film may be formed. In addition, MoSi_{2.25} and MoSi_{2.5} films may be formed in site-isolated regions 1101c and 1101d respectfully. Each MoSiₓ film formed within the site-isolated regions 1101a-1101d may have a thickness greater than than 0.01 microns.

Each of the four devices may be tested to determine the optimum material and/or processing conditions. Typical tests may include measuring the reflectance and transmittance of the deposited metal silicide films, etc. In addition, other optical or physical and electrical characteristics of the metal silicide films formed within the site-isolated regions may be evaluated and compared with each other.

FIGS. 12A-12C is a simplified schematic diagram illustrating another exemplary deposition sequence for forming a composite glass material having a metal silicide film and a protective layer formed thereon. A sequence for forming a composite glass material having a metal silicide coating formed on a glass substrate will be used as an example. Those skilled in the art will understand that the glass substrate may already have several layers formed thereon. FIG. 12A begins with the glass substrate 1200, wherein the glass substrate (or a previous material formed thereon) is operable as a base upon which a metal silicide coating is formed thereon.

In FIG. 12B, four alternatives of a first material are formed above the glass substrate 1200 wherein the first material is operable as a metal silcide coating. As illustrated in FIG. 12B, the four alternatives are formed in each of four site-isolated regions 1201a-1201d across the glass substrate 1200 which may be accomplished using a combinatorial deposition processing chamber (see FIG. 4).

In some embodiments, the first material is formed upon the glass substrate 1200 by a PVD process. In some embodiments, the first material in each site-isolated region may be formed by varying process conditions (e.g., process time, temperature, etc.). Moreover, in some embodiments, the first material formed in each site-isolated region may have different concentrations of silicide. For instance, in site-isolated region 1201a, a WSi_{1.5} film may be formed therein and in site isolated region 1201b, a WSi_{1.75} film may be formed. In addition, WSi₂₀ and WSi_{2.5} films may be formed in site-isolated regions 1201c and 1201d respectfully.

In the embodiment shown, the WSiₓ films formed within the site-isolated regions 1201a-1201d all have thicknesses far less than 1 micron (e.g., 0.001 μm, 0.005 μm, 0.01 μm, and 0.015 μm, respectively). Accordingly, a protective film may be deposited over the previously formed WSiₓ films in the site-isolated regions 1201a-1201d.

In FIG. 12C, a second material 1202a is shown formed over the deposited WSiₓ films in site-isolated regions 1201a, 1201d. Likewise a third material 1202b is formed over the deposited WSiₓ films in site-isolated regions 1201b, 1201c. The second and third materials 1202a, 1202b serve as protective layers for the thin metal silicide layers. In some embodiments, second and third materials 1202a, 1202b comprise SiO₂ being processed under different processing conditions.

Each of the four devices may be tested to determine the optimum material and/or processing conditions. Typical tests may include measuring capacitance as a function of applied voltage (i.e. C-V curve), measuring current as a function of applied voltage (i.e. I-V curve), measuring the k value of the dielectric material, measure the equivalent oxide thickness (EOT) of the dielectric material, measuring the concentration and energy levels of traps or interface states, measuring the concentration and mobility of charge carriers, and measuring the reflectance and transmittance of the deposited metal silicide films, etc. In addition, optical or physical and electrical characteristics of the metal silicide films may be evaluated and compared with each other.

Methods and systems for combinatorial processing have been described. It will be understood that the descriptions of some embodiments of the present disclosure do not limit the various alternative, modified and equivalent embodiments which may be included within the spirit and scope of the present disclosure as defined by the appended claims. Furthermore, in the detailed description above, numerous specific details are set forth to provide an understanding of various embodiments of the present disclosure. However, some embodiments of the present disclosure may be practiced without these specific details.

What is claimed is:

1. A device, comprising:
a glass substrate; and
a metal silicide coating formed over the glass substrate;
wherein the metal silicide layer has a thickness between 0.001 and 0.5 microns;
wherein the metal silicide layer is at least one of MoSiₓ, WSiₓ, VSiₓ, TiSix, TaSix, NbSix, HfSix, or ZrSix.

2. The device of claim 1, wherein the thickness of the metal silicide coating is approximately 0.1 micron.

3. The device of claim 1, wherein the device has a reflectance between 45% to 55% at a wavelength of light between 0.40 μm and 0.85 μm.

4. The device of claim 1, wherein the metal silicide layer comprises MoSiₓ.

5. The device of claim 1 further comprising a protective layer formed over the metal silicide layer.

6. The device of claim 5, wherein the protective layer comprises SiO₂.

7. The device of claim 1, wherein the device is at least one of an automobile window or a glass used within an interrogation room.

8. The device of claim 1, wherein X is a number between 1.5 and 2.5.

9. The device of claim 1, wherein the metal silicide coating has a refractive index of approximately 5.

10. The device of claim 1, wherein the metal silicide coating has a Vickers hardness in a range of 15-22 GPa.

11. A one way mirror device, comprising:
a glass substrate; and
a MoSiₓ coating formed over the glass substrate;
wherein the MoSiₓ coating has a thickness between 0.001 and 0.5 microns;
wherein the MoSiₓ coating has a reflectance of approximately 50%.

12. The one way mirror device of claim 11 further comprises a protective layer formed over the MoSiₓ layer.

13. The one way mirror device of claim 12, wherein the protective layer comprises SiO₂.

14. The one way mirror device of claim 11, wherein X is a number between 1.5 and 2.5.

15. The one way mirror device claim 11, wherein the MoSiₓ coating is an anti-scratch coating.

16. A method for performing combinatorial processing, comprising:
introducing a glass substrate into a processing chamber wherein the processing chamber comprises a sputter target assembly;
depositing one of a plurality of metal silicide films within each of a plurality of site-isolated regions defined on the substrate;
wherein each metal silicide film has a thickness between 0.001 and 0.5 microns; and
evaluating a property of the metal silicide films formed within each of the plurality of site-isolated regions.

17. The method of claim 16, wherein evaluating a property comprises comparing an optical, physical, or electrical characteristic of the metal silicide films formed within each of the plurality of site-isolated regions.

18. The method of claim 16 further comprising depositing a protective film over the metal silicide films.

19. The method of claim 16, wherein the metal silicide layer is at least one of MoSiₓ, WSiₓ, VSiₓ, TiSix, TaSix, NbSix, HfSix, or ZrSix.

20. The method of claim 19, wherein the metal silicide layer comprises MoSiₓ.
